(19) United States
(12) Patent Application Publication
(10) Pub. No.: US 2025/0240065 A1
(43) Pub. Date: Jul. 24, 2025

(54) ELECTRONIC DEVICE FOR TRANSMITTING REFERENCE SIGNAL AND OPERATION METHOD THEREOF

(71) Applicant: SAMSUNG ELECTRONICS CO., LTD., Suwon-si (KR)

(72) Inventors: Youngjin KANG, Suwon-si (KR); Joonwon JANG, Suwon-si (KR); Wonhyung HEO, Suwon-si (KR)

(21) Appl. No.: 19/072,975

(22) Filed: Mar. 6, 2025

Related U.S. Application Data
(63) Continuation of application No. PCT/KR2023/015607, filed on Oct. 11, 2023.

(30) Foreign Application Priority Data
Oct. 14, 2022 (KR) 10-2022-0132633
Nov. 10, 2022 (KR) 10-2022-0149699

(51) Int. Cl. H04B 7/06; H04B 1/40; H04B 17/18; H04L 5/00; H04W 84/12

(52) U.S. Cl. CPC H04B 7/0602; H04B 1/40; H04B 17/18; H04L 5/0048; H04W 84/12

(57) ABSTRACT

An electronic device includes at least one radio frequency integrated circuit (RFIC), a plurality of communication antennas that are connected to the at least one RFIC via at least one radio frequency front-end (RFFE) circuit and transmit signals corresponding to the at least one communication network, a Wi-Fi antenna that transmits or receives Wi-Fi signals and is connected to the at least one RFIC, at least one component, at least one processor connected to the RFIC and the at least one component and memory storing instructions. The instructions, when executed by at least one processor, cause the electronic device to transmit a reference signal to the plurality of communication antennas via the at least one RFFE circuit with an operation of the at least one component operates, detect whether an error occurs in the operation of the at least one component, and replace at least one of the plurality of communication antennas with the Wi-Fi antenna on the basis of the detection result.

### CROSS-REFERENCE TO RELATED APPLICATIONS

This application is a continuation of International Application No. PCT/KR2023/015607, designating the United States, filed on Oct. 11, 2023, in the Korean Intellectual Property Receiving Office and claiming priority to Korean Patent Application Nos. 10-2022-0132633, filed on Oct. 14, 2022, and 10-2022-0149699, filed on Nov. 10, 2022, in the Korean Intellectual Property Office, the disclosures of each of which are incorporated by reference herein in their entireties.

### TECHNICAL FIELD

An embodiment of the disclosure relates to an electronic device and an operation method for transmitting a reference signal.

### BACKGROUND ART

As mobile communication technology evolves, multi-functional portable terminals are commonplace and, to meet increasing demand for radio traffic, vigorous efforts are underway to develop 5G communication systems. To achieve a higher data transmission rate, 5G communication systems are being implemented on higher frequency bands (e.g., a band of 25 GHz to 60 GHz) as well as those used for 3G communication systems and long-term evolution (LTE) communication systems.

To implement 5G communication, stand-alone (SA) and non-stand-alone (NSA) schemes are taken into consideration. Of the two, the NSA scheme may include an E-UTRA NR dual connectivity (EN-DC) scheme that uses the new radio (NR) system along with the legacy LTE system. In the NSA scheme, user equipment (UE) may use not only eNBs of the LTE system but also gNBs of the NR system. Technology allowing UEs to use heterogeneous communication systems may be termed dual connectivity. A 5G EN-DC scheme may implement dual connectivity as proposed in 3GPP release-12 by adopting LTE network communication as a master node and NR network communication as a secondary node.

An electronic device may transmit, through at least one antenna, a reference signal (e.g., a sounding reference signal (SRS)) referenced for channel estimation by a base station in a communication network. The base station may perform multi-antenna signal processing or beamforming processing by estimating the channel based on the reference signal transmitted from the electronic device. The electronic device may enhance data reception performance by receiving a multi-antenna signal-processed or beamformed signal from the base station.

### DETAILED DESCRIPTION OF THE INVENTION

### Technical Solution

An electronic device according to an embodiment of the disclosure may comprise at least one radio frequency integrated circuit, a plurality of communication antennas connected to the at least one radio frequency integrated circuit (RFIC) through at least one radio frequency front-end circuit to transmit a signal corresponding to at least one communication network, a Wi-Fi antenna transmitting or receiving a Wi-Fi signal and connected to the at least one RFIC, at least one component, at least one processor connected to the at least one RFIC and the at least one component, and memory storing instructions. The instructions when executed by the at least one processor, may cause the electronic device to transmit a reference signal to the plurality of communication antennas through the at least one radio frequency front end (RFFE) circuit with an operation of the at least one component. The instructions when executed by the at least one processor, may cause the electronic device to detect whether an error occurs in the operation of the at least one component. The instructions when executed by the at least one processor, may cause the electronic device to replace at least one communication antenna among the plurality of communication antennas with the Wi-Fi antenna based on a result of the detection.

A method for operating an electronic device according to an embodiment of the disclosure may comprise transmitting a reference signal to the plurality of communication antennas through the at least one RFFE circuit with an operation of the at least one component. The method may comprise detecting whether an error occurs in the operation of the at least one component. The method may comprise replacing at least one communication antenna among the plurality of communication antennas with the Wi-Fi antenna based on a result of the detection.

A non-transitory, computer-readable storage medium storing instructions which, when executed by at least one processor of an electronic device may cause the electronic device to perform operations. The operations may comprise transmitting a reference signal to the plurality of communication antennas through the at least one RFFE circuit with an operation of the at least one component. The operations may comprise detecting whether an error occurs in the operation of the at least one component. The operations may comprise replacing at least one communication antenna among the plurality of communication antennas with the Wi-Fi antenna based on a result of the detection.

An electronic device according to an embodiment of the disclosure may comprise at least one radio frequency integrated circuit, a plurality of communication antennas connected to the at least one RFIC through at least one radio frequency front-end circuit to transmit a signal corresponding to at least one communication network, a Wi-Fi antenna transmitting or receiving a Wi-Fi signal and connected to the at least one RFIC, at least one component, and at least one processor connected to the at least one RFIC and the at least one component. The at least one processor may be configured to identify an operation state of the at least one component. The at least one processor may be configured to transmit the reference signal by replacing a communication antenna designated corresponding to the at least one component among the plurality of communication antennas with the Wi-Fi antenna when the at least one component is operated as a result of the identification.

### BRIEF DESCRIPTION OF THE DRAWINGS

FIG. 1 is a block diagram illustrating an electronic device in a network environment according to an embodiment of the disclosure;

FIGS. 2A and 2B are blocks diagram 200 illustrating an electronic device 101 for supporting legacy network communication and 5G network communication according to an embodiment of the disclosure;

FIG. 3 is a view illustrating wireless communication systems providing a legacy communication network and/or a 5G communication network according to an embodiment of the disclosure;

FIG. 4 is a view illustrating transmission of a reference signal by an electronic device according to an embodiment of the disclosure;

FIG. 5 is a flowchart illustrating a signal transmission/reception procedure between an electronic device and a communication network according to an embodiment of the disclosure;

FIG. 6 is a view illustrating a transmission period of a reference signal according to an embodiment of the disclosure;

FIG. 7 is a block diagram illustrating an electronic device according to an embodiment of the disclosure;

FIG. 8 is a detailed view illustrating an electronic device according to an embodiment of the disclosure;

FIG. 9A is a graph illustrating a radiation efficiency for each frequency band of a Wi-Fi antenna according to an embodiment of the disclosure;

FIG. 9B is a graph illustrating a reflection coefficient for each frequency band of a Wi-Fi antenna according to an embodiment of the disclosure;

FIG. 10 illustrates a time of occupancy when a Wi-Fi antenna transmits a reference signal according to an embodiment of the disclosure;

FIG. 11 is a flowchart illustrating an operation method of an electronic device according to a first embodiment of the disclosure; and

FIGS. 12A and 12B are flowcharts illustrating a method for operating an electronic device according to a second embodiment of the disclosure.

### MODE FOR CARRYING OUT THE INVENTION

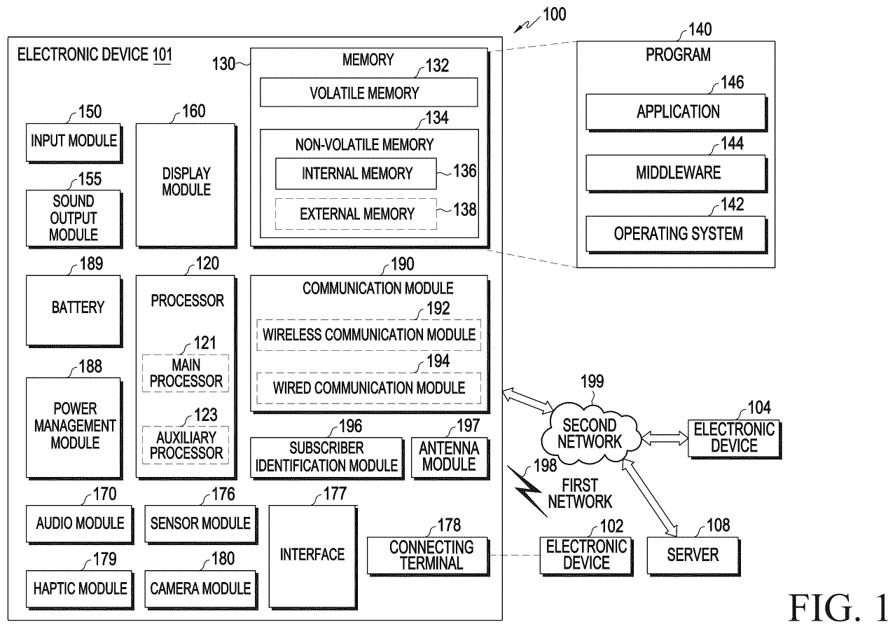

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, e.g., a gesture sensor, a gyro sensor, an atmospheric pressure sensor, a magnetic sensor, an acceleration sensor, a grip sensor, a proximity illuminance sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

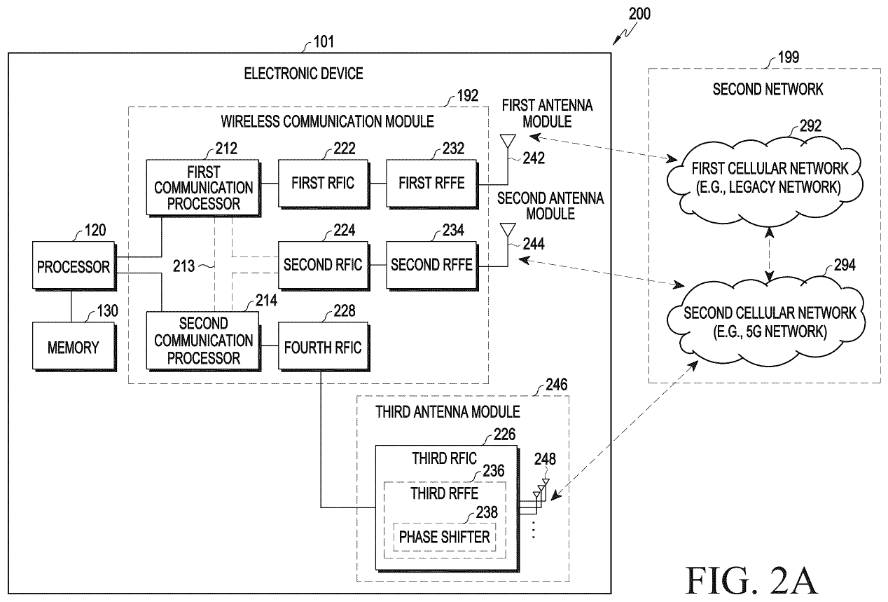

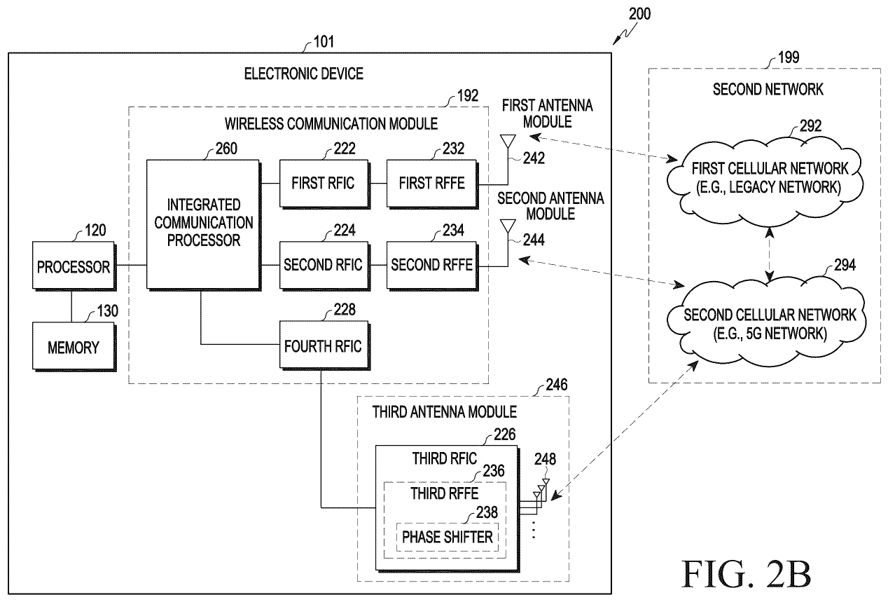

FIGS. 2A and 2B are blocks diagram 200 illustrating an electronic device 101 for supporting legacy network communication and 5G network communication according to an embodiment of the disclosure.

Referring to FIGS. 2A and 2B, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or be included as part of the third RFIC 226.

The first communication processor 212 may establish a communication channel of a band that is to be used for wireless communication with the first cellular network 292 or may support legacy network communication via the established communication channel. According to an embodiment, the first cellular network 292 may be a legacy network that includes second generation (2G), third generation (3G), fourth generation (4G), or long-term evolution (LTE) networks. The second communication processor 214 may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first CP 212 or the second CP 214 may establish a communication channel corresponding to another designated band (e.g., about 6 GHz or less) among the bands that are to be used for wireless communication with the second cellular network 294 or may support fifth generation (5G) network communication via the established communication channel.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to implementation, the first communication processor 212 may not be directly connected with the second communication processor 214. In this case, the first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

According to an embodiment, the first CP 212 and the second CP 214 may be implemented in a single chip or a single package. According to an embodiment, the first communication processor 212 or the second communication processor 214, along with the processor 120, an auxiliary processor 123, or communication module 190, may be formed in a single chip or single package. For example, as shown in FIG. 2B, an integrated communication processor 260 may support all of the functions for communication with the first cellular network 292 and the second cellular network 294.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHZ) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

According to an embodiment, the first RFIC 222 and the second RFIC 224 may be implemented as at least part of a single chip or single package. According to an embodiment, when the first RFIC 222 and the second RFIC 224 in FIG. 2A or 2B are implemented as a single chip or a single package, they may be implemented as an integrated RFIC. In this case, the integrated RFIC is connected to the first RFFE 232 and the second RFFE 234 to convert a baseband signal into a signal of a band supported by the first RFFE 232 and/or the second RFFE 234, and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

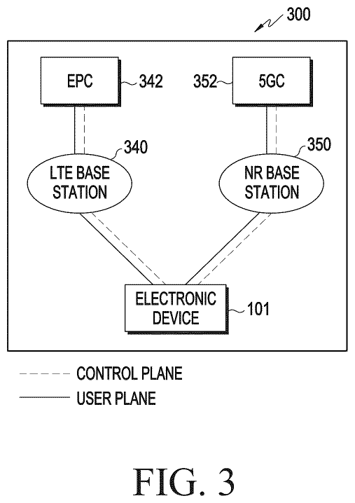

FIG. 3 is a view illustrating wireless communication systems providing a legacy communication network and/or a 5G communication network according to an embodiment of the disclosure.

Referring to FIG. 3, the network environment 300 may include at least one of a legacy network and a 5G network. The legacy network may include, e.g., a 3GPP-standard 4G or LTE base station (e.g., an eNodeB (eNB)) that supports radio access with the electronic device 101 and an evolved packet core (EPC) that manages 4G communication. The 5G network may include, e.g., a new radio (NR) base station (e.g., a gNodeB (gNB)) that supports radio access with the electronic device 101 and a 5th generation core (5GC) that manages 5G communication for the electronic device 101.

According to an embodiment, the electronic device 101 may transmit or receive control messages and user data via legacy communication and/or 5G communication. The control messages may include messages related to at least one of, e.g., security control, bearer setup, authentication, enrollment, or mobility management of the electronic device 101. The user data may mean, e.g., user data except for control messages transmitted or received between the electronic device 101 and the core network (e.g., the EPC 342 and the 5GC 352).

Referring to FIG. 3, according to an embodiment, the electronic device 101 may transmit or receive at least one of a control message or user data to/from at least part (e.g., the NR base station or 5GC) of the 5G network via at least part (e.g., the LTE base station or EPC) of the legacy network.

According to an embodiment, the network environment 300 may include a network environment that provides wireless communication dual connectivity (DC) to the LTE base station and the NR base station and transmits or receives control messages to/from the electronic device 101 via one core network of the EPC or the 5GC.

According to an embodiment, in the DC environment, one of the LTE base station 340 or the NR base station 350 may operate as a master node (MN), and the other as a secondary node (SN). The MN may be connected to the core network to transmit and receive control messages. The MN and the SN may be connected with each other via a network interface to transmit or receive messages related to radio resource (e.g., communication channel) management therebetween.

According to an embodiment, in E-UTRA new radio dual connectivity (EN-DC), the MN may include the LTE base station, the SN may include the NR base station, and the core network may include the EPC. For example, control messages may be transmitted/received via the LTE base station and the EPC, and user data may be transmitted/received at least one of the LTE base station or the NR base station.

According to an embodiment, in new radio dual E-UTRA connectivity (NE-DC), the MN may include the NR base station 350, the SN may include the LTE base station 340, and the core network may include the 5GC. For example, control messages may be transmitted/received via the NR base station 350 and the 5GC 352, and user data may be transmitted/received at least one of the LTE base station 340 or the NR base station 350.

According to an embodiment, the electronic device 101 may be registered in at least one of the EPC 342 or the 5GC 352 to transmit or receive control messages.

According to an embodiment, the EPC 342 or the 5GC 352 may interwork with each other to manage communication for the electronic device 101. For example, mobility information for the electronic device 101 may be transmitted or received via the interface between the EPC 342 and the 5GC 352.

Besides the EN-DC, the MR DC may have other various applications. For example, a first network and a second network by the MR DC may be both related to LTE communication, and the second network may be a network corresponding to a small cell of a specific frequency. For example, the first network and the second network by the MR DC may be both related to 5G, and the first network may correspond to a frequency band (e.g., below 6) less than 6 GHz, and the second network may correspond to a frequency band (e.g., over 6) not less than 6 GHz. It will be easily appreciated by one of ordinary skill in the art that other various dual-connectivity-applicable network structures may be applied to embodiments of the disclosure.

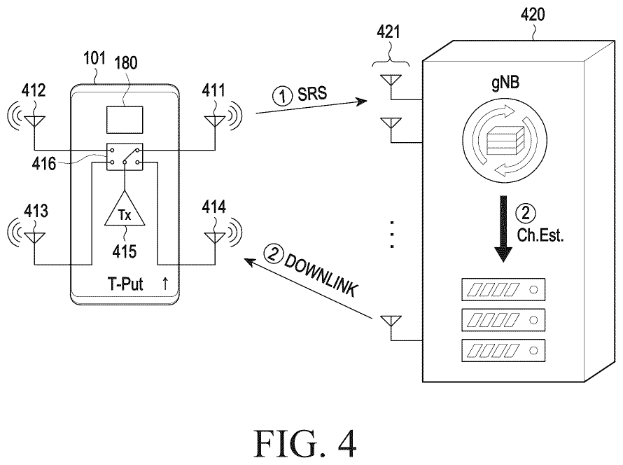

FIG. 4 is a view illustrating transmission of a reference signal by an electronic device according to an embodiment of the disclosure.

Referring to FIG. 4, an electronic device 101 (e.g., the electronic device 101 of FIG. 1) may transmit a reference signal (e.g., an SRS) through four antennas (e.g., a first antenna 411, a second antenna 412, a third antenna 413, and a fourth antenna 414). For example, the electronic device 101 may amplify the reference signal through at least one power amplifier (PA) 415 and may transmit the amplified reference signal to the first antenna 411, the second antenna 412, the third antenna 413, and the fourth antenna 414 through at least one switch 416. The reference signal (e.g., an SRS) transmitted through each antenna (e.g., the first antenna 411, the second antenna 412, the third antenna 413, and the fourth antenna 414) of the electronic device 101 may be received through each antenna 421 of a base station 420 (e.g., a gNB).

According to an embodiment, the base station 420 may receive the reference signal transmitted from the electronic device 101 and may estimate the channel (channel estimation) for each antenna (e.g., the first antenna 411, the second antenna 412, the third antenna 413, and the fourth antenna 414) of the electronic device 410 from the received reference signal. The base station 420 may transmit a precoded downlink signal to the electronic device 101 based on the channel estimation. For example, the electronic device 101 and the base station 420 may perform MIMO communication. According to an embodiment, the base station 420 may perform beamforming based on channel estimation in an FR2 band.

Although FIG. 4 illustrates one power amplifier 415 and one switch 416 connected with a plurality of antennas (a first antenna 411, a second antenna 412, a third antenna 413, and a fourth antenna 414) for ease of description, it will readily be appreciated by one of ordinary skill in the art that embodiments of the disclosure are not limited thereto.

As illustrated in FIG. 4, if the electronic device 101 transmits a reference signal (e.g., an SRS) through a plurality of transmission paths, the base station 420 may identify the channel environment with each antenna (e.g., the first antenna 411, the second antenna 412, the third antenna 413, and the fourth antenna 414)) of the electronic device 101 and may use the identified channel environment for precoding (or beamforming), enhancing the reference signal received power (RSRP) and/or signal to noise ratio (SNR) of the downlink channel. If the RSRP and/or SNR of the downlink channel is enhanced, the rank index (RI) or channel quality indicator (CQI) for the electronic device may be increased. The base station 420 allocates a high rank or modulation and code schemes (MCS) to the electronic device 101 based on the enhanced performance of the electronic device 101 so that the downlink throughput of the electronic device 101 may be enhanced.

According to an embodiment, the base station 420 may use a downlink reference signal for downlink channel estimation. For example, if the base station 420 transmits the downlink reference signal to the electronic device 101, the electronic device 101 may receive the downlink reference signal transmitted from the base station 420 and perform channel estimation. The electronic device 101 may transmit the result of channel estimation to the base station 420, and the base station 420 may perform downlink beamforming with reference to the result of the channel estimation transmitted from the electronic device 101. According to an embodiment, when the base station 420 performs channel estimation by the reference signal (e.g., an SRS) transmitted from the electronic device 101, channel estimation may be performed faster than the channel estimation by the downlink reference signal,

According to an embodiment, a first communication network (e.g., a base station (gNB)) or a second communication network (e.g., a base station (gNB)) may send a request for various configuration information for the electronic device 101 by transmitting a UE capability enquiry message to the electronic device 101. For example, a first communication network (e.g., a base station (gNB)) or a second communication network (e.g., a base station (eNB)) may send a request for information related to the reception antenna of the electronic device 101 through the UE capability enquiry message. The electronic device 101 may receive the UE capability enquiry message from the first communication network or the second communication network and, in response thereto, may transmit a UE capability information message to the first communication network or the second communication network. According to an embodiment, information related to the reception antenna of the electronic device 101, such as ‘supportedSRS-TxPortSwitch t1r4,’ may be included in the UE capability information message, according to the content of the UE capability enquiry message.

According to an embodiment, the electronic device 101 may support 1T4R to amplify the reference signal through one power amplifier (PA) 415 at four antennas 411, 412, 413, and 414 and transmit the amplified reference signal to the first antenna 411, the second antenna 412, the third antenna 413, and the fourth antenna 414 through at least one switch 416. Here, all of the four antennas 411, 412, 413, and 414 may be used only for TX, but may include one RRX antenna and three DRX antennas. The PRX antenna is an antenna used for both data transmission and data reception, and thus may be connected to a TX RF path based on the power amplifier (PA) 415 and an RX RF path based on an LNA (not shown). The DRX antenna is an antenna used only for data reception, but may be used for transmitting a reference signal (e.g., SRS).

As the antenna-related information is specified as ‘supportedSRS-TxPortSwitch t1r4’, the first communication network may determine that the electronic device 101 may transmit signals using four reception antennas and transmit an RRC reconfiguration message including information for the time of transmission of a reference signal (e.g., an SRS) for each of the four antennas.

In an embodiment, a camera module 180 may be positioned adjacent to the first antenna 411 and/or the second antenna 412. In an embodiment, when the camera module 180 transmits a reference signal from the first antenna 411 and/or the second antenna 412, there may be a possibility of malfunction due to signal interference.

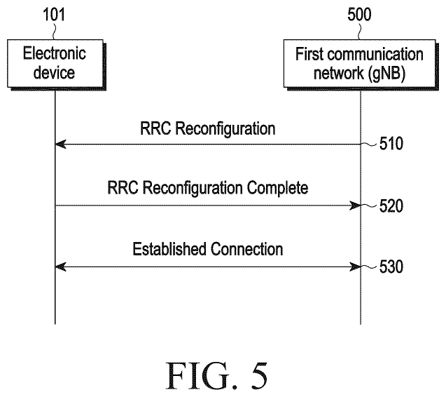

FIG. 5 is a flowchart illustrating a signal transmission/reception procedure between an electronic device and a communication network according to an embodiment of the disclosure.

Referring to FIG. 5, an electronic device 101 may establish an RRC connection with a first communication network (e.g., a base station (gNB)) 600 through a random access channel (RACH) procedure.

According to an embodiment, in operation 510, the first communication network 500 may transmit an RRC reconfiguration message to the electronic device 101. For example, the first communication network 500 may transmit an RRC reconfiguration message in response to the RRC request message transmitted by the electronic device 101. As described above, the RRC reconfiguration message may include information regarding a time point at which the electronic device 101 transmits a reference signal (e.g., an SRS) through each antenna as follows.
perodicityAndOffset-p s120: 17
perodicityAndOffset-p s120: 7
perodicityAndOffset-p s120: 13
perodicityAndOffset-p s120: 3
nrofSymbols n1

Referring to the RRC reconfiguration message, it may be seen that as specified as “nrofSymbols n1.”, the duration of SRS transmission may be determined as an allocated symbol. Further, referring to the RRC reconfiguration message, as specified as “periodicityAndOffset-p s120: 17”, the first SRS may be set to be transmit in the 17th slot while being transmitted once every 20 slots. As specified as “periodicityAndOffset-p s120: 7”, the second SRS may be set to be transmitted in the 7th slot while being transmitted once every 20 slots. As specified as “periodicityAndOffset-p s120: 13”, the third SRS is transmitted in the 13th slot while being transmitted once every 20 slots. As specified as “periodicityAndOffset-p s120: 3”, the fourth SRS is set to be transmit in the 3rd slot while being transmitted once every 20 slots.

According to an embodiment, the electronic device 101 may transmit four SRSs at different times through the respective antennas every 20 slots according to the configuration of RRC reconfiguration. The size of one slot may be determined by the subcarrier spacing (SCS). For example, when the SCS is 30 KHz, the time interval of one slot may be 0.5 ms, and the time interval of 20 slots may be 10 ms. Accordingly, the electronic device 101 may repeatedly transmit the SRS at different times through the respective antennas every 10 ms. According to an embodiment, one slot may include 14 symbols and, assuming that one symbol is allocated for one SRS transmission, it may have a symbol duration (or symbol enable time) of 0.5 ms*1/14=35 μs (0.035 ms).

According to an embodiment, in operation 520, the electronic device 101 may transmit an RRC reconfiguration complete message to the first communication network 500. As the RRC reconfiguration procedure is normally completed, in operation 530, the electronic device 101 and the first communication network 600 may complete RRC connection establishment.

According to an embodiment, as described above, the electronic device 101 may transmit reference signals at different times for each time period (e.g., 10 ms) set through each antenna transmission path based on information regarding the transmission time of the reference signal (e.g., an SRS) received from the first communication network 500 as described above.

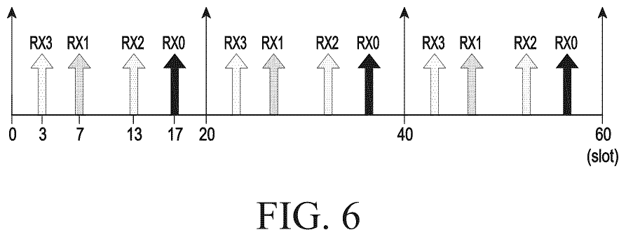

FIG. 6 is a view illustrating a transmission period of a reference signal according to an embodiment of the disclosure.

Referring to FIG. 6, e.g., the electronic device 101 may transmit the first SRS in the 17th slot among 20 slots every 10 ms, the second SRS in the 7th slot, the third SRS in the 13th slot, and the fourth SRS in the third slot. For example, the electronic device 101 may include four reception antennas, supporting 1T4R (e.g., a scenario in which among the four antennas, one antenna is mapped for transmission purposes). The electronic device 101 may transmit an SRS signal through each of four reception antennas (e.g., RX0, RX1, RX2, and RX3 of FIG. 6).

According to an embodiment, the reference signal may be a sounding reference signal (SRS) used for multi-antenna signal processing (e.g., multi input multi output (MIMO) or beamforming) through uplink channel state measurement, but embodiments of the disclosure are not limited thereto. For example, although SRS is used as an example of the reference signal in the above description or the following description, any type of uplink reference signal (e.g., uplink demodulation reference signal (DM-RS)) transmitted from the electronic device 101 to the base station signal may be included in the reference signal described below.

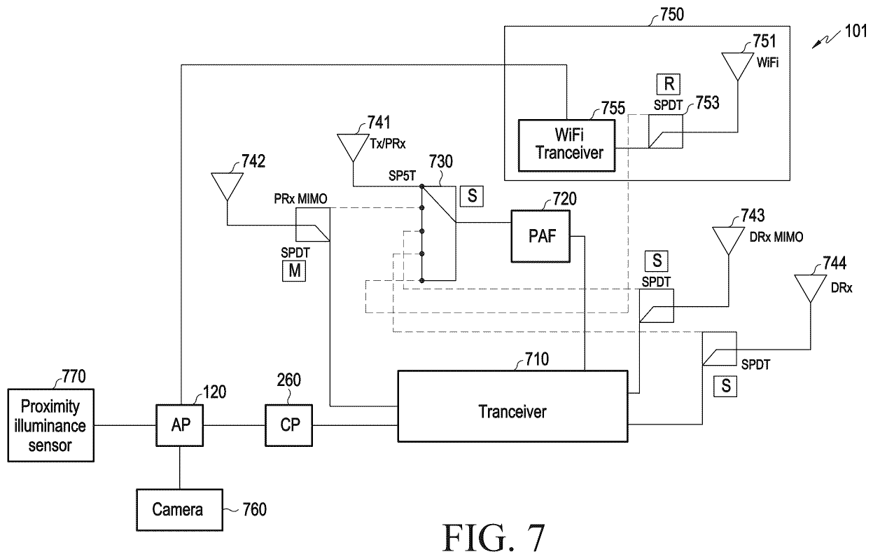

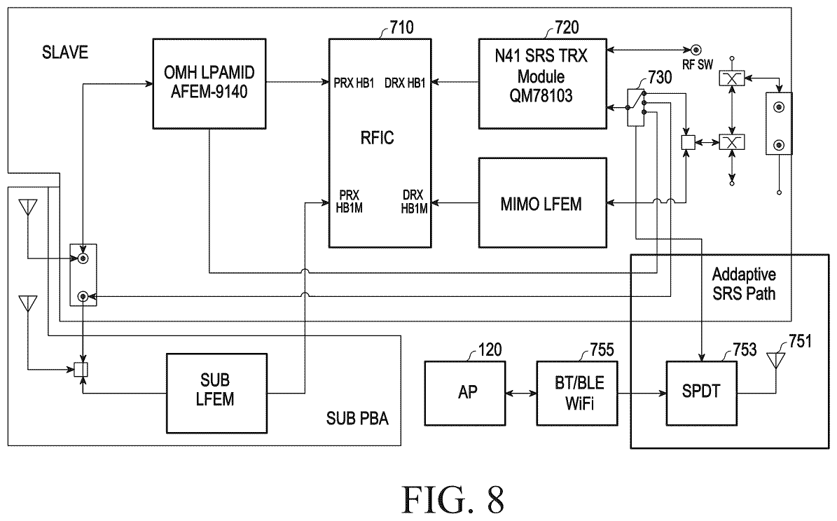

FIG. 7 is a block diagram illustrating an electronic device 101 according to an embodiment of the disclosure. FIG. 8 is a detailed diagram illustrating an electronic device 101 according to an embodiment of the disclosure.

Referring to FIGS. 7 and 8, the electronic device 101 according to an embodiment may include at least one radio frequency integrated circuits (RFIC) 710 (e.g., the first RFIC 222, the second RFIC 224, the third RFIC 226, and the fourth RFIC 228 of FIGS. 2A and 2B), a plurality of communication antennas 741, 742, 743, and 744 (e.g., the antenna module 197 of FIG. 1 or the first antenna module 242, the second antenna module 244, the third antenna module 246, and the antennas 248 of FIG. 2A) connected to the at least one RFIC through at least one radio frequency front-end (RFFE) circuit 720 or 730 (e.g., the first RFFE 232, the second RFFE 234, and the third RFFE 236 of FIG. 2A), a Wi-Fi antenna 751 connected to the at least one RFIC 710, at least one component 760 or 770, and/or at least one processor 120 or 260 (e.g., the processor 120 of FIG. 1) connected to the at least one RFIC 710 and the at least one component 760 or 770.

In an embodiment, the electronic device 101 may include at least one RFIC 710 that converts a baseband signal into a transmitted radio frequency (RF) signal corresponding to at least one communication network. In an embodiment, the radio frequency RF signal may be in a high frequency band of 2.4 to 3.5 GHZ, such as N41/77/78. In an embodiment, at least one RFIC 710 may transmit a radio frequency signal of a specific frequency band through the RFFE circuit 720 or 730 upon transmission, and upon reception, receive a preprocessed radio frequency signal through the RFFE circuit 720 or 730 and convert it into a baseband signal.

In an embodiment, the RFFE circuit 720 or 730 may be provided in each of the plurality of communication antennas 741, 742, 743, and 744 to connect at least one RFIC 710 with at least one of the plurality of communication antennas 741, 742, 743, and 744. For example, the RFFE circuit 720 or 730 may be formed as a portion of at least one RFIC 710. In an embodiment, the RFFE circuit 720 or 730 may include at least one power amplifier (PAF) 720 and/or at least one switch 730.

In an embodiment, the plurality of communication antennas 741, 742, 743, and 744 each may be connected to the RFFE circuit 720 or 730 to transmit or receive signals. In an embodiment, the plurality of communication antennas 741, 742, 743, and 744 include at least one data transmission antenna PRX, and may include at least one data reception antenna DRX, and use all of the data transmission antenna PRX and the data reception antenna DRX as reference signal transmission (SRS TX Path) at the operator's request and to increase data throughput. An SPDT switch may be disposed on each of the plurality of communication antennas 741, 742, 743, and 744.

For example, the plurality of communication antennas 741, 742, 743, and 744 may have a 1T4R structure including one data transmission antenna PRX and three data reception antennas DRX, or a 2T4R structure including two data transmission antennas PRX and two data reception antennas DRX.

In an embodiment, the electronic device 101 may amplify a reference signal (e.g., an SRS signal) generated by a transceiver implemented as the RFIC 710 through at least one power amplifier (PAF) 720 included in the RFFE circuit 720 or 730, and transmit the amplified reference signal to the first antenna 741, the second antenna 742, the third antenna 743, or the fourth antenna 744 through at least one switch 730.

In an embodiment, the Wi-Fi module 750 may transmit or receive a Wi-Fi signal generated by a Wi-Fi transceiver 755 and include a Wi-Fi antenna 751 connected to at least one RFIC 710. In an embodiment, the Wi-Fi switch 753 may be of a single pole double throw (SPDT) type that selectively connects the Wi-Fi transceiver 755 and at least one RFIC 710 to the Wi-Fi antenna 751 to selectively transmit a Wi-Fi signal generated by the Wi-Fi transceiver 755 or a reference signal generated by at least one RFIC 710 to the Wi-Fi antenna 751.

Here, Wi-Fi is a representative wireless communication network of wireless local area network (WLAN) establishing a network using radio waves and be referred to as a ‘wireless LAN’ and be used as the same meaning. In an embodiment, the antenna resonance of the Wi-Fi antenna 751 may be adjusted to a band corresponding to 2.4 to 4 GHz.

In an embodiment, a first module (not shown) included in the Wi-Fi module 750 may include a first RF circuit (not shown) that performs at least one of transmission and reception of a Wi-Fi signal in a first frequency band and a second RF circuit (not shown) that performs at least one of transmission and reception of a Wi-Fi signal in a second frequency band, and a second module network slice may include a third RF circuit network slice that performs at least one of transmission and reception of a Wi-Fi signal in the first frequency band and a four RF circuit network slice that performs at least one of transmission and reception of a Wi-Fi signal in the second frequency band. For example, the first frequency band may be a frequency band including 2.4 GHz, and the second frequency band may be a frequency band including 5.0 GHz.

In an embodiment, the Wi-Fi antenna 751 includes at least one antenna, and at least one antenna of the Wi-Fi antenna 751 may be electrically connected to each of at least one of the first RF circuit (not shown) to the fourth RF circuit (not shown). In an embodiment, when the Wi-Fi module 750 intends to transmit transmission (Tx) data using each circuit, the Wi-Fi module 750 may transmit the Wi-Fi signal by alternately using the first module (not shown) and the second module (not shown).

In an embodiment, at least two Wi-Fi antennas 751 may be provided for each designated frequency band, and for example, four Wi-Fi antennas may be provided when there are two frequency bands. As is described below, when the plurality of communication antennas 741, 742, 743, and 744 are replaced with the Wi-Fi antenna 751, any one of the at least one or more antennas included in the Wi-Fi antenna 751 may be designated to transmit a reference signal, or any one of the at least one or more antennas included in the plurality of Wi-Fi antennas 751 may be selectively used.

In an embodiment, when malfunction or performance degradation (e.g., image quality degradation in the case of cameras) occurs in the operation of at least one component 760 or 770, the electronic device 101 may identify an optimal Wi-Fi antenna 751 to replace one of the plurality of communication antennas 741, 742, 743, and 744, or may designate a Wi-Fi antenna 751 to replace corresponding to the components 760 and 770.

When receiving a Wi-Fi signal, the Wi-Fi module according to an embodiment may maintain a 2*2 MIMO mode simultaneously using the first module and the second module but, when transmitting a Wi-Fi signal, may restrict the first module and the second module not to operate at the same time. According to an embodiment, during any scheduled time, only the module responsible for one connection may perform data transmission.

The electronic device 101 according to an embodiment may include a switch capable of selectively connecting at least some of the plurality of communication antennas 741, 742, 743, and 744 and the Wi-Fi antenna 751 to at least one RFIC 710. In an embodiment, the operation of the switch may be controlled by the application processor 120, and the switch may connect at least some of the plurality of communication antennas 741, 742, 743, and 744 and the Wi-Fi antenna 751 to the at least one RFIC 710 through at least one RFFE circuit 720 and 730.

In an embodiment, the switch may be of a single pole five throw (SP5T) type that transmits the reference signal transmitted from at least one RFIC 710 to one of the plurality of communication antennas 741, 742, 743, and 744 or the Wi-Fi antenna 751. In an embodiment, the first communication antenna is always connected to at least one RFIC 710, and the switch may be of a single pole four throw (SP4T) type that transmits to the Wi-Fi antenna 751 or one other than the first communication antenna 741 among the plurality of communication antennas 741, 742, 743, and 744.

At least one processor 120, 260 according to an embodiment may include an application processor (AP) 120 and/or a communication processor (CP) 260. In an embodiment, the communication processor 260 may be operated by a command of the application processor 120 or may transmit and receive data to and from each other. Here, the operation of the at least one processor 120 and 260 may be an operation performed by the application processor 120 or the communication processor 260, but is not limited thereto.

At least one component 760 or 770 according to an embodiment may include, e.g., a camera 760 or a proximity illuminance sensor 770 as a component such as various sensors controlled by the application processor 120. In an embodiment, when the camera 760 or the proximity illuminance sensor 770 operates simultaneously at the time of transmission of the reference signal, a problem may occur in the operation such as an interruption or a red line due to signal interference with the transmission power of the reference signal.

In an embodiment, at least one component 760 or 770 may internally perform an error count of communication such as camera I2C or MIPI, and detect that an operation problem has occurred when an error occurs a designated threshold number of times or more. In an embodiment, while transmitting and receiving data with at least one component 760 or 770, the application processor 120 may detect whether a problem occurs in the operation of at least one component 760 or 770.

In an embodiment, the designated threshold may be designated according to the type of the components 760 and 770. For example, the threshold may be set to 1 (times) for a front camera (VT CAM), the threshold may be set to 1 (times) for a wide-angle camera (Wide CAM), the threshold may be set to 1 (times) for an ultra wide-angle camera (Ultra Wide CAM), and the threshold may be set to 1 (times) for a telephoto camera (Tele CAM). In other words, in the case of the front camera (VT CAM), the wide-angle camera (Wide CAM), the ultra-wide CAM, and the telephoto camera (Tele CAM), if one or more errors occur as a result of the error count, it may be detected that a problem has occurred in the operation.

In an embodiment, the electronic device 101 (e.g., the application processor 120 or the communication processor 260) may control to transmit antenna-related information including information 1T4R indicating supporting one transmission antenna and four reception antennas to the base station of at least one communication network through the plurality of communication antennas 741, 742, 743, and 744.

In an embodiment, the electronic device 101 may control to transmit the reference signal to the plurality of communication antennas 741, 742, 743, and 744 through at least one RFFE circuit. In an embodiment, the reference signal may include a sounding reference signal (SRS) used for multi-antenna signal processing through uplink channel state measurement.

In an embodiment, the electronic device 101 may receive information related to the transmission time of the reference signal corresponding to each of the four receiving antennas from the base station, and control to transmit the plurality of reference signals through the communication antennas 741, 742, 743, and 744, respectively, at different times based on the information related to the transmission time of the received reference signal. In an embodiment, the electronic device 101 may control to transmit (e.g., sweep or change the frequency over time) the reference signal by sequentially using the plurality of communication antennas 741, 742, 743, and 744 corresponding to the transmission time of the received reference signal.

In an embodiment, the electronic device 101 may operate at least one component 760 or 770 while transmitting the reference signal through the plurality of communication antennas 741, 742, 743, and 744. In an embodiment, when operating at least one component 760 or 770 while transmitting the reference signal through the plurality of communication antennas 741, 742, 743, and 744, the electronic device 101 may detect whether an error occurs in the operation of at least one component 760 or 770.

In an embodiment, when detecting that an error has occurred in the operation of at least one component 760, 770, the electronic device 101 may control to replace at least one of the plurality of communication antennas 741, 742, 743, and 744 with the Wi-Fi antenna 751 to transmit the reference signal.

In an embodiment, the electronic device 101 may identify at least one communication antenna to be replaced with the Wi-Fi antenna 751 among the plurality of communication antennas 741, 742, 743, and 744. The electronic device 101 may identify at least one communication antenna that causes an error in the operation of at least one component 760 or 770 while sequentially replacing the plurality of communication antennas 741, 742, 743, and 744 with the Wi-Fi antenna 751.

In an embodiment, the electronic device 101 may control to replace one of the plurality of communication antennas 741, 742, 743, and 744 with the Wi-Fi antenna 751, and transmit the reference signal sequentially (e.g., sweeping) using the Wi-Fi antenna 751 with the plurality of communication antennas 741, 742, 743, and 744 one of which has been replaced with the Wi-Fi antenna 751. The electronic device 101 may identify at least one communication antenna by detecting whether an error occurs in the operation of at least one component 760 or 770 while sequentially changing one of the plurality of communication antennas 741, 742, 743, and 744 replaced with the Wi-Fi antenna 751.

In an embodiment, the electronic device 101 may control to transmit (e.g., sweep) the reference signal using the plurality of communication antennas 741, 742, 743, and 744 while sequentially changing one of the plurality of communication antennas 741, 742, 743, and 744 (e.g., fourth communication antenna→third communication antenna→second communication antenna). For example, the electronic device 101 may detect whether an error occurs in the operation of at least one component 760 or 770 while controlling transmission (e.g., sweeping or changing the frequency over time) of the reference signal in the first embodiment (first communication antenna 741→second communication antenna 742→third communication antenna 743→Wi-Fi antenna 751), the second embodiment (first communication antenna 741→second communication antenna 742→fourth communication antenna 744→Wi-Fi antenna 751) and/or the third embodiment (first communication antenna 741→third communication antenna 743→fourth communication antenna 744→Wi-Fi antenna 751).

In an embodiment, the first communication antenna 741 may not cause signal interference with the component 760 and 770 as the data transmission antenna and, accordingly, the first communication antenna 741 may be excluded from one among the plurality of communication antennas 741, 742, 743, and 744 to be replaced with the Wi-Fi antenna 751.

In an embodiment, the electronic device 101 may identify one communication antenna that generates an error in the operation of at least one component 760 or 770 among the plurality of communication antennas 741, 742, 743, and 744 according to transmitting (sweeping) the reference signal by sequentially using the plurality of communication antennas 741, 742, 743, and 744 while sequentially changing one of the plurality of communication antennas 741, 742, 743, and 744.

For example, the electronic device 101 may identify that the fourth communication antenna 744 generates an error in the operation of at least one component 760 or 770 when the error in the operation of the at least one component 760 or 770 is removed while transmitting (sweeping) the reference signal in the first embodiment (first communication antenna 741→second communication antenna 742→third communication antenna 743→Wi-Fi antenna 751).

For example, the electronic device 101 may identify that the third communication antenna 743 generates an error in the operation of at least one component 760 or 770 when the error in the operation of the at least one component 760 or 770 is removed while transmitting (sweeping) the reference signal in the second embodiment (first communication antenna 741→second communication antenna 742→fourth communication antenna 744→Wi-Fi antenna 751).

For example, the electronic device 101 may identify that the second communication antenna 742 generates an error in the operation of at least component 760 or 770 when the error in the operation of the at least one component 760 or 770 is removed while transmitting (sweeping) the reference signal in the third embodiment (first communication antenna 741→third communication antenna 743→fourth communication antenna 744→Wi-Fi antenna 751).

In an embodiment, the electronic device 101 may control to replace at least one communication antenna identified as having generated an error in the operation of the at least one component 760 or 770 among the plurality of communication antennas 741, 742, 743, and 744 with the Wi-Fi antenna 751 to transmit the reference signal. In an embodiment, the electronic device 101 may transmit the reference signal to a designated path through the plurality of communication antennas 741, 742, 743, and 744 or transmit the reference signal to a changed path in which at least one of the plurality of communication antennas 741, 742, 743, and 744 has been replaced with the Wi-Fi antenna 751.

In an embodiment, the electronic device 101 may store at least one communication antenna corresponding to the at least one component 760 or 770 based on the result of identifying the at least one communication antenna to be replaced with the Wi-Fi antenna 751. For example, when the third communication antenna 743 is identified as generating an error in the operation of the camera 760, the electronic device 101 may replace the third communication antenna 743 with the Wi-Fi antenna 751 to transmit the reference signal and match and store the operation of the camera 760 and the third communication antenna 743.

For example, when the fourth communication antenna 744 is identified as generating an error in the operation of the proximity illuminance sensor 770, the electronic device 101 may replace the fourth communication antenna 744 with the Wi-Fi antenna 751 to transmit the reference signal and match and store the operation of the proximity illuminance sensor 770 and the fourth communication antenna 744.

In an embodiment, the electronic device 101 may control to replace a communication antenna designated corresponding to the at least one component 760 or 770 among the plurality of communication antennas 741, 742, 743, and 744 with the Wi-Fi antenna 751 to transmit the reference signal. In an embodiment, when a result of previously identifying the communication antenna generating an error in the operation of the at least one component 760 or 770 is pre-stored in the memory (e.g., the memory 130 of FIG. 1) or the at least one component 760 or 770 is operated together with transmission of the reference signal based on the data received from the outside and previously stored, the electronic device 101 may control to replace the communication antenna stored corresponding to the corresponding component 760 or 770 among the plurality of communication antennas 741, 742, 743, and 744 to transmit the reference signal.

In an embodiment, the electronic device 101 may identify one or more operation states of at least one component 760 or 770, and may control the transmission of the reference signal to the plurality of communication antennas 741, 742, 743, and 744 based on the identified operation state of at least one component 760, 770. The operation states include: a “stopped” operation state; an “active” operation state; and a “no communication antenna designated” operation state.

In an embodiment, when the operation state of the at least one component 760 or 770 is identified as stopped, the electronic device 101 may control to transmit the reference signal to the plurality of communication antennas 741, 742, 743, and 744 again without replacement with the Wi-Fi antenna 751.

In an embodiment, when the operation state of the at least one component 760 or 770 operates is identified as actively operating (e.g., active), the electronic device 101 may control to replace the communication antenna designated corresponding to the at least one component 760 or 770 among the plurality of communication antennas 741, 742, 743, and 744 with the Wi-Fi antenna 751 to transmit the reference signal.

In an embodiment, when the identified operation state is no communication antenna designated corresponding to the at least one component 760 or 770, the electronic device 101 may control to transmit the reference signal to the plurality of communication antennas 741, 742, 743, and 744 through at least one RFFE circuit, detect whether an error occurs in the operation of the at least one component 760 or 770, and control to replace at least one communication antenna among the plurality of communication antennas 741, 742, 743, and 744 with the Wi-Fi antenna 751 to transmit the reference signal based on the result of the detection.

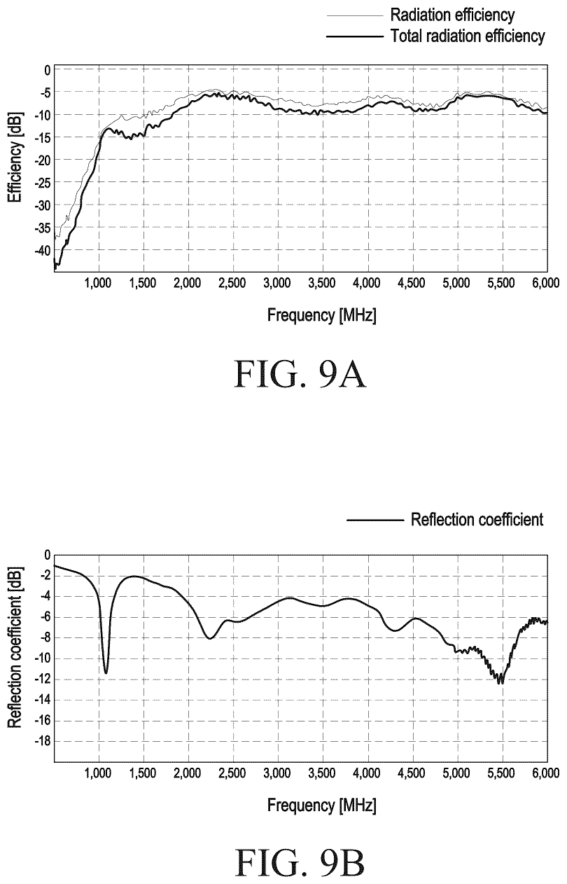

FIG. 9A is a graph illustrating a radiation efficiency for each frequency band of a Wi-Fi antenna according to an embodiment of the disclosure. FIG. 9B is a graph illustrating a reflection coefficient for each frequency band of a Wi-Fi antenna according to an embodiment of the disclosure.

Referring to FIGS. 9A to 9B, the Wi-Fi antenna (e.g., the Wi-Fi antenna 751 of FIG. 7) is aligned to antenna resonance in the band of 2.4 to 5 GHZ, and thus has sufficient radiation efficiency and reflection coefficient in the N77/78 band of 3.5 GHz as well as the N41 band of 2.4 GHz.

Therefore, the Wi-Fi antenna may implement sufficient performance to transmit the reference signal of 2.4 to 3.5 GHz in the N41/77/78 band.

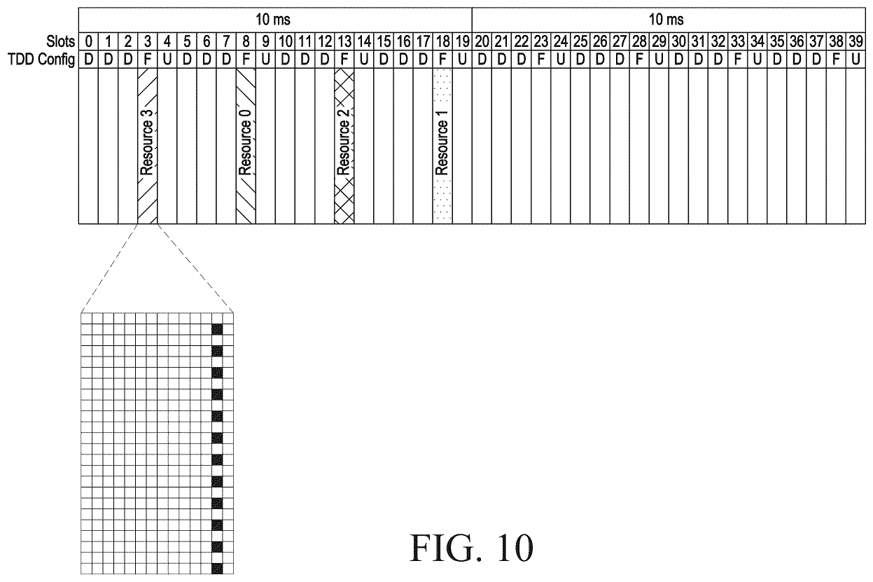

FIG. 10 illustrates a time of occupancy when a Wi-Fi antenna transmits a reference signal according to an embodiment of the disclosure.

Referring to FIG. 10, the time required for one reference signal (e.g., SRS) transmission operation when transmitting or receiving an actual NR signal through a Wi-Fi antenna (e.g., the Wi-Fi antenna 751 of FIG. 7) is 0.5 (ms), as colored in the 10 (ms) signal. In other words, the reference signal transmission operation may occupy only 5% of the actual NR signal transmission through the Wi-Fi antenna.

Therefore, there is no problem even when the transmission/reception of Wi-Fi signals and the transmission of the reference signal through the Wi-Fi antenna operate simultaneously. For example, even in the case of Bluetooth (BT), it operates simultaneously with the Wi-Fi signal in a time sharing scheme, but neither of the two communications causes a problem due to performance deterioration. Therefore, the transmission operation of the reference signal, which requires only a relatively shorter signal than the Bluetooth signal, does not affect the use and performance of transmitting and receiving the Wi-Fi signal.

Actually, in a state in which the electronic device (e.g., the electronic device 101 of FIG. 1) is connected to the network via Wi-Fi communication, reference signal transmission operation is not performed because it is in the call connected-idle state of LTE and NR. Accordingly, in the general environment, such an occasion where transmission/reception of the Wi-Fi signal and transmission of the reference signal are simultaneously operated does not occur.

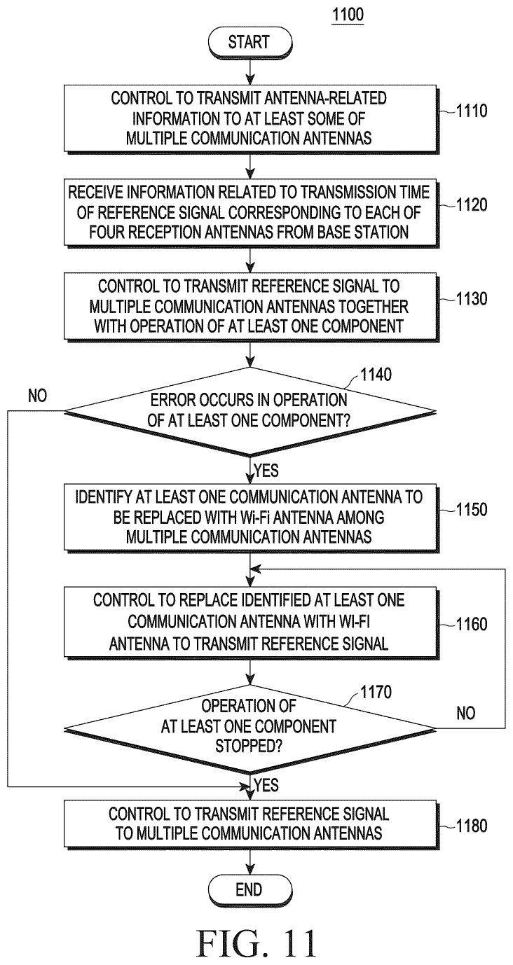

FIG. 11 is a flowchart 1100 illustrating an operation method of an electronic device according to a first embodiment of the disclosure.

Referring to FIG. 11, the electronic device (e.g., the electronic device 101 or the processor 120 of FIG. 1) according to an embodiment may control, in operation 1110, to transmit antenna-related information through at least some of the plurality of communication antennas to the base station of at least one communication network. In an embodiment, the electronic device includes a plurality of communication antennas including at least four antennas, and the antenna-related information may include information indicating that one transmission antenna and four reception antennas are supported.

In operation 1120, the electronic device according to an embodiment may receive information related to the transmission time of the reference signal corresponding to each of the four receiving antennas from the base station of at least one communication network in response to transmission of antenna-related information.

The electronic device according to an embodiment may control to transmit the reference signal to the plurality of communication antennas together with the operation of at least one component in operation 1130. The electronic device may control to operate at least one component by an input corresponding to the at least one component, and control to transmit the reference signal to the plurality of communication antennas when a designated condition is met while the at least one component is operated.

In an embodiment, the reference signal may include a sounding reference signal (SRS) used for multi-antenna signal processing through uplink channel state measurement.

The electronic device according to an embodiment may detect whether an error occurs in the operation of the at least one component while transmitting the reference signal to the plurality of communication antennas along with the operation of the at least one component in operation 1140. In an embodiment, the electronic device 101 may determine that an error occurs in the operation of at least one component when a threshold number of errors occur as the result of the error count for the errors generated in the at least one component.

In an embodiment, the electronic device 101 may control to transmit the reference signal to the plurality of communication antennas in operation 1180 when detecting that no error occurs in the operation of the at least one component.

The electronic device according to an embodiment, upon detecting that an error occurs in the at least one component, may identify at least one communication antenna to be replaced with the Wi-Fi antenna among the plurality of communication antennas in operation 1150.

The electronic device according to an embodiment may detect whether an error occurs in the operation of the at least one component while sequentially replacing the plurality of communication antennas with the Wi-Fi antenna. The electronic device may replace one of the plurality of communication antennas with the Wi-Fi antenna and accordingly detect whether an error occurs in the operation of the at least one component.

In an embodiment, the electronic device may identify the communication antenna replaced with the Wi-Fi antenna as the communication antenna to be replaced with the Wi-Fi antenna in the embodiment in which the error has been removed from the operation of the at least one component while sequentially replacing the plurality of communication antennas with the Wi-Fi antenna.

The electronic device according to an embodiment may control to replace the identified at least one communication antenna with the Wi-Fi antenna to transmit the reference signal in operation 1160. The electronic device may identify the communication antenna generating an error in the operation of the at least one component, and replace it with the Wi-Fi antenna to generate the reference signal.

The electronic device according to an embodiment may identify the operation state of the at least one component in operation 1170. The electronic device may identify whether the at least one component stops operation as a result of identifying the operation state. In an embodiment, the electronic device may control to replace the identified at least one communication antenna with the Wi-Fi antenna to transmit the reference signal in operation 1160, when identifying that the operation of the at least one component is stopped.

The electronic device according to an embodiment may control to transmit the reference signal to the plurality of communication antennas in operation 1180 when identifying that the operation of the at least one component is stopped. When the operation of the at least one component where an error occurs in the operation is stopped upon transmitting the reference signal through the plurality of communication antennas, the electronic device may return to transmit the reference signal through the plurality of communication antennas.

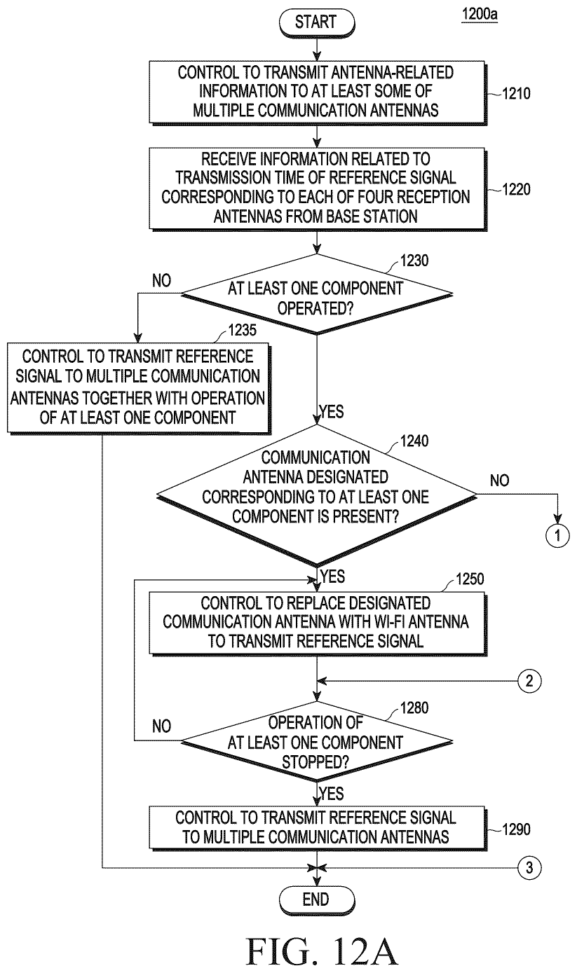

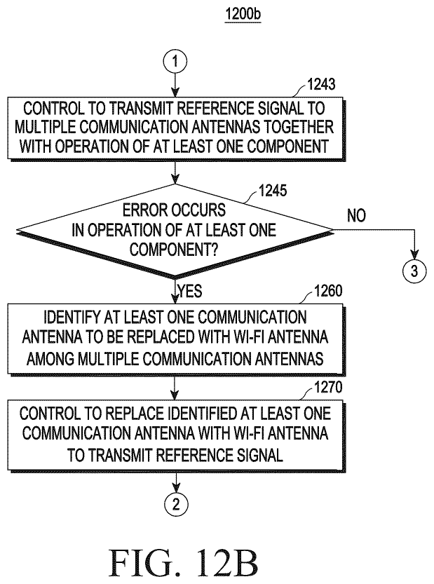

FIGS. 12A and 12B are flowcharts 1200a and 1200b illustrating a method for operating an electronic device according to a second embodiment of the disclosure.

Referring to FIGS. 12A and 12B, the electronic device (e.g., the electronic device 101 or the processor 120 of FIG. 1) according to an embodiment may control, in operation 1210, to transmit antenna-related information through at least some of the plurality of communication antennas to the base station of at least one communication network.

In operation 1220, the electronic device according to an embodiment may receive information related to the transmission time of the reference signal corresponding to each of the four receiving antennas from the base station of at least one communication network in response to transmission of antenna-related information.

The electronic device according to an embodiment may identify the operation state of the at least one component in operation 1230. In an embodiment, the electronic device may identify whether the at least one component is operated. In an embodiment, the at least one component may include various sensors such as a proximity illuminance sensor or at least one camera, and the electronic device may identify the component operating among designated at least one component.

When the at least one component is not operated, the electronic device according to an embodiment may control to transmit the reference signal to the plurality of communication antennas together with the operation of at least one component in operation 1235.

When the at least one component is operated, the electronic device according to an embodiment may identify whether there is a communication antenna designated corresponding to the at least one component in operation 1240. In an embodiment, the electronic device may identify whether there is a communication antenna designated corresponding to the operating component among the at least one component.

In an embodiment, as shown in FIG. 4, the first antenna 411 and/or the second antenna 412 included in the plurality of communication antennas may be disposed adjacent to the camera module 180, and thus there may be a possibility that the first antenna 411 and/or the second antenna 412 may malfunction under the influence of the first antenna 411 and/or the second antenna 412 in a state in which the camera module 180 operates. In an embodiment, for the camera module 180, the first antenna 411 or the second antenna 412 may be designated as the designated communication antenna.

When there is a communication antenna designated corresponding to the at least one component, the electronic device according to an embodiment may control to replace the designated communication antenna among the plurality of communication antennas with the Wi-Fi antenna to transmit the reference signal in operation 1250.

When there is no communication antenna designated corresponding to the at least one component, the electronic device according to an embodiment may control to transmit the reference signal to the plurality of communication antennas through at least one RFFE circuit in operation 1243.

In operation 1245, the electronic device according to an embodiment may detect whether an error occurs in the operation of the at least one component. In an embodiment, when no error occurs in the operation of the at least one component, the electronic device may control to continuously transmit the reference signal to the plurality of communication antennas together with the operation of the at least one component.

The electronic device according to an embodiment, when an error occurs in the at least one component, may identify at least one communication antenna to be replaced with the Wi-Fi antenna among the plurality of communication antennas in operation 1260. In an embodiment, the electronic device may transmit the reference signal while sequentially replacing the plurality of communication antennas with the Wi-Fi antenna and, upon transmitting the reference signal, detect whether an error occurs in the operation of the at least one component.

The electronic device according to an embodiment may control to replace the identified at least one communication antenna with the Wi-Fi antenna to transmit the reference signal in operation 1270.

The electronic device according to an embodiment may identify the operation state of the at least one component in operation 1280. The electronic device may identify whether the at least one component stops operation as a result of identifying the operation state.

In an embodiment, the electronic device may control to replace the identified at least one communication antenna with the Wi-Fi antenna to transmit the reference signal in operation 1250, when identifying that the operation of the at least one component is stopped.

The electronic device according to an embodiment may control to transmit the reference signal to the plurality of communication antennas in operation 1290 when identifying that the operation of the at least one component is stopped.

An electronic device 101 according to an embodiment of the disclosure may comprise at least one radio frequency integrated circuit (RFIC) 212, 224, 226, 228; 710, a plurality of communication antennas 197; 242, 244, 246, 248; 741, 742, 743, 744 connected to the at least one RFIC 222, 224, 226, 228; 710 through at least one radio frequency front-end (RFFE) circuit to transmit a signal corresponding to at least one communication network, a Wi-Fi antenna 751 transmitting or receiving a Wi-Fi signal and connected to the at least one RFIC 222, 224, 226, 228; 710, at least one component 760, 770, and at least one processor 120; 212, 214; 260 connected to the at least one RFIC 222, 224, 226, 228; 710 and the at least one component 760, 770. The at least one processor 120; 212, 214; 260 may be configured to control transmission of a reference signal to the plurality of communication antennas 197; 242, 244, 246, 248; 741, 742, 743, 744 through the at least one RFFE circuit 232, 234, 236; 720, 730 together with an operation of the at least one component 760, 770. The at least one processor 120; 212, 214; 260 may be configured to detect whether an error occurs in the operation of the at least one component 760, 770. The at least one processor 120; 212, 214; 260 may be configured to control to replace at least one communication antenna among the plurality of communication antennas 197; 242, 244, 246, 248; 741, 742, 743, 744 with the Wi-Fi antenna 751 to transmit the reference signal, based on a result of the detection.

In the electronic device 101 according to an embodiment, the reference signal may include a sounding reference signal (SRS) used for multi-antenna signal processing through uplink channel state measurement.

In the electronic device 101 according to an embodiment, the plurality of communication antennas 197; 242, 244, 246, 248; 741, 742, 743, 744 may include at least four antennas. The at least one processor 120; 212, 214; 260 may be configured to control transmission of antenna-related information including information indicating supporting one transmission antenna and four reception antennas to a base station of the at least one communication network through at least some of the plurality of communication antennas 197; 242, 244, 246, 248; 741, 742, 743.

In the electronic device 101 according to an embodiment, the at least one processor 120; 212, 214; 260 may be configured to receive information related to a transmission time of the reference signal corresponding to each of the four reception antennas from the base station. The at least one processor 120; 212, 214; 260 may be configured to: as at least part of controlling transmission of the reference signal to the plurality of communication antennas 197; 242, 244, 246, 248; 741, 742, 743, 744, transmit a plurality of reference signals through the plurality of communication antennas 197; 242, 244, 246, 248; 741, 742, 743, 744, respectively, at different times, based on the received information related to the transmission time of the reference signal.

In the electronic device 101 according to an embodiment, the at least one component 760, 770 may be at least any one of at least one or more cameras 760 or at least one or more sensors 176; 770.

In the electronic device 101 according to an embodiment, the at least one processor 120; 212, 214; 260 may be configured to identify the at least one communication antenna to be replaced with the Wi-Fi antenna 751 among the plurality of communication antennas 197; 242, 244, 246, 248; 741, 742, 743, 744. The at least one processor 120; 212, 214; 260 may be configured to: as at least part of controlling to replace with the Wi-Fi antenna 751 to transmit the reference signal, control to replace the identified at least one communication antenna with the Wi-Fi antenna 751 to transmit the reference signal.

In the electronic device 101 according to an embodiment, the at least one processor 120; 212, 214; 260 may be configured to, as at least part of identifying the at least one communication antenna to be replaced with the Wi-Fi antenna 751, detect whether an error occurs in the operation of the at least one component 760, 770 while sequentially replacing the plurality of communication antennas 197; 242, 244, 246, 248; 741, 742, 743, 744 with the Wi-Fi antenna.

In the electronic device 101 according to an embodiment, the at least one processor 120; 212, 214; 260 may be configured to store the at least one communication antenna corresponding to the at least one component 760, 770 based on a result of identifying the at least one communication antenna to be replaced with the Wi-Fi antenna.

In the electronic device 101 according to an embodiment, the at least one processor 120; 212, 214; 260 may be configured to, as at least part of controlling to replace with the Wi-Fi antenna 751 to transmit the reference signal, control to replace a communication antenna designated corresponding to the at least one component 760, 770 among the plurality of communication antennas 197; 242, 244, 246, 248; 741, 742, 743, 744 with the Wi-Fi antenna 751 to transmit the reference signal.

In the electronic device 101 according to an embodiment, the at least one processor 120; 212, 214; 260 may be configured to identify an operation state of the at least one component 760, 770. The at least one processor 120; 212, 214; 260 may be configured to control transmission of the reference signal to the plurality of communication antennas 197; 242, 244, 246, 248; 741, 742, 743, 744 based on the identified operation state of the at least one component 760.

The electronic device 101 according to an embodiment may further comprise a switch capable of selectively connecting at least some of the plurality of communication antennas 197; 242, 244, 246, 248; 741, 742, 743, 744 and the Wi-Fi antenna 751 to the at least one RFIC 222, 224, 226, 228; 710.

A method for operating an electronic device 101 according to an embodiment of the disclosure may comprise transmitting a reference signal to the plurality of communication antennas 197; 242, 244, 246, 248; 741, 742, 743, 744 through the at least one RFFE circuit 232, 234, 236; 720, 730 together with an operation of the at least one component 760, 770. The method for operating the electronic device 101 according to an embodiment may comprise detecting whether an error occurs in the operation of the at least one component 760, 770. The method for operating the electronic device 101 according to an embodiment may comprise controlling to replace at least one communication antenna among the plurality of communication antennas 197; 242, 244, 246, 248; 741, 742, 743, 744 with the Wi-Fi antenna 751 to transmit the reference signal, based on a result of the detection.

In the method for operating the electronic device 101 according to an embodiment, the reference signal may include a sounding reference signal (SRS) used for multi-antenna signal processing through uplink channel state measurement.

In the method for operating the electronic device 101 according to an embodiment, the plurality of communication antennas 197; 242, 244, 246, 248; 741, 742, 743, 744 may include at least four antennas, and the method may further comprise transmitting antenna-related information including information indicating supporting one transmission antenna and four reception antennas to a base station of the at least one communication network through at least some of the plurality of communication antennas 197; 242, 244, 246, 248; 741, 742, 743, 744.

The method for operating the electronic device 101 according to an embodiment may comprise receiving information related to a transmission time of the reference signal corresponding to each of the four reception antennas from the base station. Controlling transmission of the reference signal to the plurality of communication antennas 197; 242, 244, 246, 248; 741, 742, 743, 744 may include transmitting a plurality of reference signals through the plurality of communication antennas 197; 242, 244, 246, 248; 741, 742, 743, 744, respectively, at different times, based on the received information related to the transmission time of the reference signal.

The method for operating the electronic device 101 according to an embodiment may further comprise identifying at least one communication antenna to be replaced with the Wi-Fi antenna 751 among the plurality of communication antennas 197; 242, 244, 246, 248; 741, 742, 743, 744. Controlling to replace with the Wi-Fi antenna 751 to transmit the reference signal may include replacing the identified at least one communication antenna with the Wi-Fi antenna 751 to transmit the reference signal.

In the method for operating the electronic device 101 according to an embodiment, identifying the at least one communication antenna to be replaced with the Wi-Fi antenna 751 may include detecting whether an error occurs in the operation of the at least one component 760, 770 while sequentially replacing the plurality of communication antennas 197; 242, 244, 246, 248; 741, 742, 743, 744 with the Wi-Fi antenna.

A non-transitory, computer-readable storage medium storing one or more programs according to an embodiment of the disclosure may comprise, based on execution of an application, transmitting a reference signal to a plurality of communication antennas 197; 242, 244, 246, 248; 741, 742, 743, 744 through at least one RFFE circuit 232, 234, 236; 720, 730 together with an operation of at least one component 760, 770. The storage medium according to an embodiment may comprise detecting whether an error occurs in the operation of the at least one component 760, 770. The storage medium according to an embodiment may comprise controlling to replace at least one communication antenna among the plurality of communication antennas 197; 242, 244, 246, 248; 741, 742, 743, 744 with the Wi-Fi antenna 751 to transmit the reference signal, based on a result of the detection.

An electronic device 101 according to an embodiment of the disclosure may comprise at least one radio frequency integrated circuit (RFIC) 212, 224, 226, 228; 710, a plurality of communication antennas 197; 242, 244, 246, 248; 741, 742, 743, 744 connected to the at least one RFIC 222, 224, 226, 228; 710 through at least one radio frequency front-end (RFFE) circuit to transmit a signal corresponding to at least one communication network, a Wi-Fi antenna 751 transmitting or receiving a Wi-Fi signal and connected to the at least one RFIC 222, 224, 226, 228; 710, at least one component 760, 770, and at least one processor 120; 212, 214; 260 connected to the at least one RFIC 222, 224, 226, 228; 710 and the at least one component 760, 770. The at least one processor 120; 212, 214; 260 may be configured to identify an operation state of the at least one component 760, 770. The at least one processor 120; 212, 214; 260 may be configured to control to replace a communication antenna designated corresponding to the at least one component 760, 770 among the plurality of communication antennas 197; 242, 244, 246, 248; 741, 742, 743, 744 with the Wi-Fi antenna 751 to transmit the reference signal when the at least one component 760, 770 is operated as a result of the identification.

In the electronic device 101 according to an embodiment of the disclosure, the at least one processor 120; 212, 214; 260 may be configured to control transmission of the reference signal to the plurality of communication antennas 197; 242, 244, 246, 248; 741, 742, 743, 744 through the at least one RFFE circuit 232, 234, 236; 720, 730 when the at least one component 760, 770 is not operated as a result of the identification.

In the electronic device 101 according to an embodiment of the disclosure, the at least one processor 120; 212, 214; 260 may be configured to control transmission of the reference signal to the plurality of communication antennas 197; 242, 244, 246, 248; 741, 742, 743, 744 through the at least one RFFE circuit 232, 234, 236; 720, 730 when there is no communication antenna designated corresponding to the at least one component 760, 770. The at least one processor 120; 212, 214; 260 may be configured to detect whether an error occurs in the operation of the at least one component 760, 770. The at least one processor 120; 212, 214; 260 may be configured to control to replace at least one communication antenna among the plurality of communication antennas 197; 242, 244, 246, 248; 741, 742, 743, 744 with the Wi-Fi antenna 751 to transmit the reference signal, based on a result of the detection.

The electronic device according to an embodiment may be one of various types of electronic devices. The electronic devices may include, for example, a portable communication device (e.g., a smart phone), a computer device, a portable multimedia device, a portable medical device, a camera, an electronic device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
at least one radio frequency integrated circuit (RFIC);
a plurality of communication antennas which are connected to the at least one RFIC through at least one radio frequency front-end (RFFE) circuit, and transmit a signal corresponding to at least one communication network;
a Wi-Fi antenna transmitting or receiving a Wi-Fi signal and connected to the at least one RFIC;
at least one component;
at least one processor connected to the at least one RFIC and the at least one component, wherein the at least one processor is configured to:
memory storing instructions which, when executed by the at least one processor, cause the electronic device to:
transmit a reference signal to the plurality of communication antennas through the at least one RFFE circuit with an operation of the at least one component;
detect whether an error occurs in the operation of the at least one component; and
replace at least one communication antenna among the plurality of communication antennas with the Wi-Fi antenna based on a result of the detection.

2. The electronic device of claim 1, wherein the reference signal includes a sounding reference signal (SRS) used for multi-antenna signal processing through uplink channel state measurement.

3. The electronic device of claim 1, wherein the plurality of communication antennas include at least four antennas, and
wherein the instructions which, when executed by the at least one processor, cause the electronic device transmit antenna-related information including information indicating a support of one transmission antenna and four reception antennas to a base station of the at least one communication network through at least some of the plurality of communication antennas.

4. The electronic device of claim 3, wherein the instructions which, when executed by the at least one processor, cause the electronic device to:
receive information related to a transmission time of the reference signal corresponding to each of the four reception antennas from the base station; and
transmit a plurality of reference signals through the plurality of communication antennas, respectively, at different times, based on the received information related to the transmission time of the reference signal.

5. The electronic device of claim 1, wherein the at least one component is at least one of at least one camera or at least one sensor.

6. The electronic device of claim 1, wherein the instructions which, when executed by the at least one processor, cause the electronic device to:
identify the at least one communication antenna to be replaced with the Wi-Fi antenna among the plurality of communication antennas; and
replace the identified at least one communication antenna with the Wi-Fi antenna.

7. The electronic device of claim 6, wherein the instructions which, when executed by the at least one processor, cause the electronic device to, as at least part of identifying the at least one communication antenna to be replaced with the Wi-Fi antenna, detect whether an error occurs in the operation of the at least one component while sequentially replacing the plurality of communication antennas with the Wi-Fi antenna.

8. The electronic device of claim 7, wherein the instructions which, when executed by the at least one processor, cause the electronic device to store the at least one communication antenna corresponding to the at least one component based on identifying the at least one communication antenna to be replaced with the Wi-Fi antenna.

9. The electronic device of claim 1, wherein the instructions which, when executed by the at least one processor, cause the electronic device to, replacing a communication antenna designated corresponding to the at least one component among the plurality of communication antennas with the Wi-Fi antenna.

10. The electronic device of claim 1, wherein the instructions which, when executed by the at least one processor, cause the electronic device to:
identify an operation state of the at least one component; and
transmit the reference signal to the plurality of communication antennas based on the identified operation state of the at least one component.

11. The electronic device of claim 1, further comprising a switch capable of selectively connecting at least some of the plurality of communication antennas and the Wi-Fi antenna to the at least one RFIC.

12. A method for operating an electronic device including at least one radio frequency integrated circuit (RFIC), a plurality of communication antennas which are connected to the at least one RFIC through at least one radio frequency front-end (RFFE) circuit and configured to transmit a signal corresponding to at least one communication network, a Wi-Fi antenna transmitting or receiving a Wi-Fi signal and connected to the at least one RFIC, and at least one component, the method comprising:
transmitting a reference signal to the plurality of communication antennas through the at least one RFFE circuit with an operation of the at least one component;
detecting whether an error occurs in the operation of the at least one component; and
replacing at least one communication antenna among the plurality of communication antennas with the Wi-Fi antenna based on a result of the detection.

13. The method of claim 12, wherein the reference signal includes a sounding reference signal (SRS) used for multi-antenna signal processing through uplink channel state measurement.

14. The method of claim 12, wherein the plurality of communication antennas include at least four antennas, and
wherein the method further comprises transmitting antenna-related information including information indicating a support of one transmission antenna and four reception antennas to a base station of the at least one communication network through at least some of the plurality of communication antennas.

15. The method of claim 14, further comprising receiving information related to a transmission time of the reference signal corresponding to each of the four reception antennas from the base station,
wherein transmitting the reference signal to the plurality of communication antennas comprises transmission of a plurality of reference signals through the plurality of communication antennas, respectively, at different times, based on the received information related to the transmission time of the reference signal.

16. The method of claim 12, wherein the at least one component includes at least one of at least one camera or at least one sensor.

17. The method of claim 12, further comprising:
identifying the at least one communication antenna to be replaced with the Wi-Fi antenna among the plurality of communication antennas; and
replacing the identified at least one communication antenna with the Wi-Fi antenna.

18. The method of claim 17, wherein identifying the at least one communication antenna to be replaced with the Wi-Fi antenna comprises detecting whether an error occurs in the operation of the at least one component while sequentially replacing the plurality of communication antennas with the Wi-Fi antenna.

19. The method of claim 18, further comprising:
storing the at least one communication antenna corresponding to the at least one component based on identifying the at least one communication antenna to be replaced with the Wi-Fi antenna.

20. A non-transitory computer readable storage medium storing instructions which, when executed by at least one processor of an electronic device including at least one radio frequency integrated circuit (RFIC), a plurality of communication antennas which are connected to the at least one RFIC through at least one radio frequency front-end (RFFE) circuit and transmit a signal corresponding to at least one communication network, and a Wi-Fi antenna transmitting or receiving a Wi-Fi signal and connected to the at least one RFIC, at least one component, cause the electronic device to perform operations, the operations comprising:
transmitting a reference signal to the plurality of communication antennas through the at least one RFFE circuit with an operation of the at least one component;
detecting whether an error occurs in the operation of the at least one component; and
controlling transmission of the reference signal by replacing at least one communication antenna among the plurality of communication antennas with the Wi-Fi antenna based on a result of the detection.
